(19) United States
(12) Patent Application Publication
(10) Pub. No.: US 2021/0302223 A1
(43) Pub. Date: Sep. 30, 2021

(54) SYSTEM AND METHOD FOR DETERMINING LAUNDRY LOAD WEIGHT WITHIN A WASHING MACHINE APPLIANCE

(71) Applicant: Haier US Appliance Solutions, Inc., Wilmington, DE (US)

(72) Inventors: Ryan Ellis Leonard, Louisville, KY (US); Stephen Edward Hettinger, Louisville, KY (US)

(21) Appl. No.: 16/832,099

(22) Filed: Mar. 27, 2020

(51) Int. Cl. G01G 19/56; D06F 34/18; D06F 34/20; D06F 33/37; D06F 33/34; D06F 33/40

(52) U.S. Cl. CPC G01G 19/56; D06F 34/18; D06F 34/20; D06F 2103/04; D06F 33/34; D06F 33/40; D06F 33/37

(57) ABSTRACT

A washing machine appliance includes a wash tub defining a wash chamber, a wash basket rotatably mounted within the wash tub, and a motor operably coupled to the wash basket for selectively rotating the wash basket. A controller is configured for accelerating the wash basket at a predetermined acceleration rate during an acceleration period while monitoring various acceleration parameters. The controller also rotates the wash basket at a predetermined speed during a steady state period either before or after the acceleration period while measuring steady state parameters. The controller further determines a load score based at least in part on the acceleration parameters and the steady state parameters and determines a load weight based on the load score, the acceleration parameters, the steady state parameters, and a weighted transfer function.

### FIELD OF THE INVENTION

The present subject matter relates generally to washing machine appliances, or more specifically, to systems and methods for determining load weight within a washing machine appliance.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Notably, it is frequently desirable to determine the load weight of a load of clothes within the washing machine appliance, e.g., in order to optimize water usage, agitation time, agitation profile selection, and other wash parameters. In addition, the spin speed of the basket may frequently need to be limited based on load weight, e.g., due to the allowed system stresses and operating dynamics. However, conventional load weight detection requires complicated and costly sensors and such systems frequently suffer from inaccurate measurements, resulting in relatively poor wash performance.

Accordingly, a washing machine appliance with features for improved load weight detection would be desirable. More specifically, a system and method for monitoring load weight without complex sensors or algorithms would be particularly beneficial.

### BRIEF DESCRIPTION OF THE INVENTION

Advantages of the invention will be set forth in part in the following description, or may be apparent from the description, or may be learned through practice of the invention.

In accordance with one exemplary embodiment of the present disclosure, a washing machine appliance is provided, including a wash tub positioned within a cabinet and defining a wash chamber, a wash basket rotatably mounted within the wash tub and being configured for receiving of a load of articles for washing, and a motor operably coupled to the wash basket for selectively rotating the wash basket. A controller is operably coupled to the motor for accelerating the wash basket at a predetermined acceleration rate during an acceleration period, periodically obtaining acceleration parameters during the acceleration period, rotating the wash basket at a predetermined speed during a steady state period either before or after the acceleration period, and obtaining steady state parameters during the steady state period. The controller is also configured for determining a load score based at least in part on the acceleration parameters and the steady state parameters and determining a load weight based on the load score, the acceleration parameters, the steady state parameters, and a weighted transfer function.

In accordance with another exemplary embodiment of the present disclosure, a method of operating a washing machine appliance is provided. The washing machine appliance includes a wash basket rotatably mounted within a wash tub and a motor operably coupled to the wash basket for selectively rotating the wash basket. The method includes accelerating the wash basket at a predetermined acceleration rate during an acceleration period, periodically obtaining acceleration parameters during the acceleration period, rotating the wash basket at a predetermined speed during a steady state period either before or after the acceleration period, and obtaining steady state parameters during the steady state period. The method further includes determining a load score based at least in part on the acceleration parameters and the steady state parameters and determining a load weight based on the load score, the acceleration parameters, the steady state parameters, and a weighted transfer function.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary washing machine appliance according to an exemplary embodiment of the present subject matter.

FIG. 2 provides a side cross-sectional view of the exemplary washing machine appliance of FIG. 1.

FIG. 3 illustrates a method for determining a load score and/or load weight in a washing machine appliance in accordance with one embodiment of the present disclosure.

FIG. 4 provides an exemplary plot of a wash basket speed and a motor power over a typically load weight detection cycle according to an exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

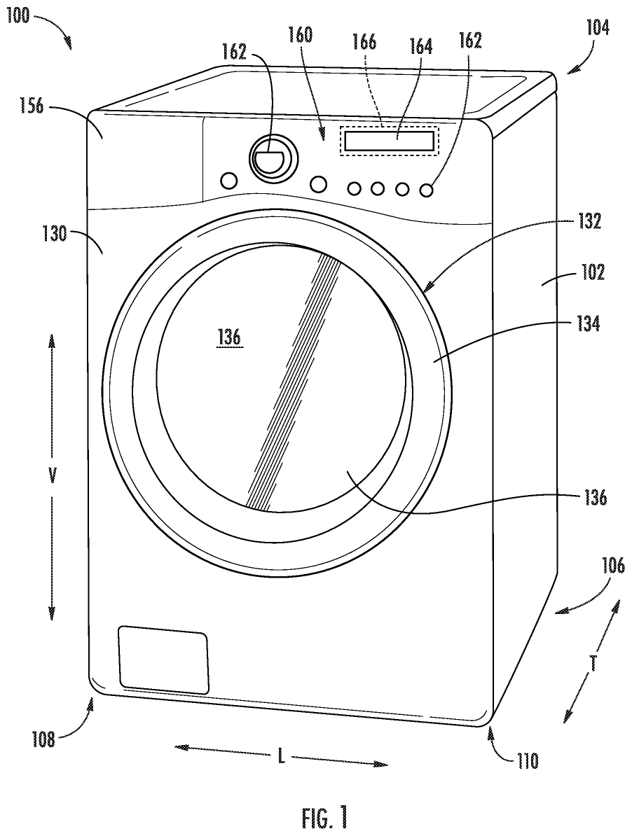

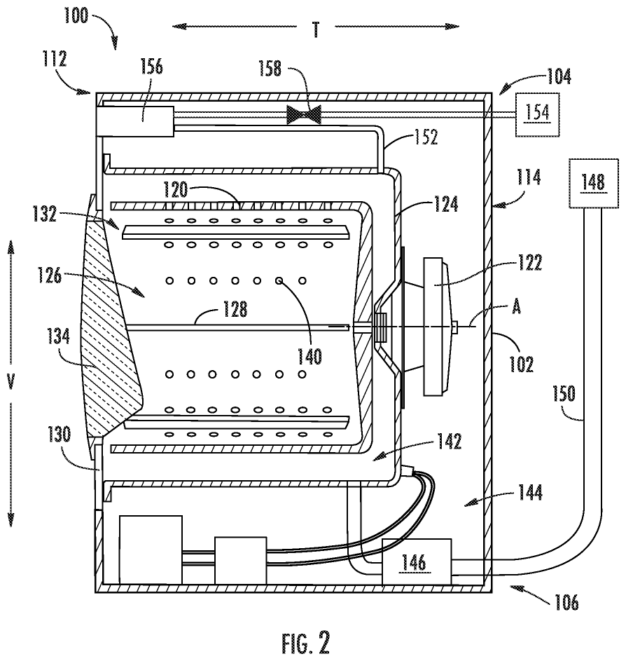

Referring now to the figures, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive.

In addition, a water supply valve or control valve 158 may provide a flow of water from a water supply source (such as a municipal water supply 154) into detergent dispenser 156 and into wash tub 124. In this manner, control valve 158 may generally be operable to supply water into detergent dispenser 156 to generate a wash fluid, e.g., for use in a wash cycle, or a flow of fresh water, e.g., for a rinse cycle. It should be appreciated that control valve 158 may be positioned at any other suitable location within cabinet 102. In addition, although control valve 158 is described herein as regulating the flow of “wash fluid,” it should be appreciated that this term includes, water, detergent, other additives, or some mixture thereof.

A control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through opening 132, and washing operation is initiated through operator manipulation of input selectors 162. Wash tub 124 is filled with water, detergent, and/or other fluid additives, e.g., via spout 152 and or detergent drawer 156. One or more valves (e.g., control valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Now that the construction of washing machine appliance 100 and the configuration of controller 166 according to exemplary embodiments have been presented, an exemplary method 200 of operating a washing machine appliance will be described. Although the discussion below refers to the exemplary method 200 of operating washing machine appliance 100, one skilled in the art will appreciate that the exemplary method 200 is applicable to the operation of a variety of other washing machine appliances, such as vertical axis washing machine appliances. In exemplary embodiments, the various method steps as disclosed herein may be performed by controller 166 or a separate, dedicated controller.

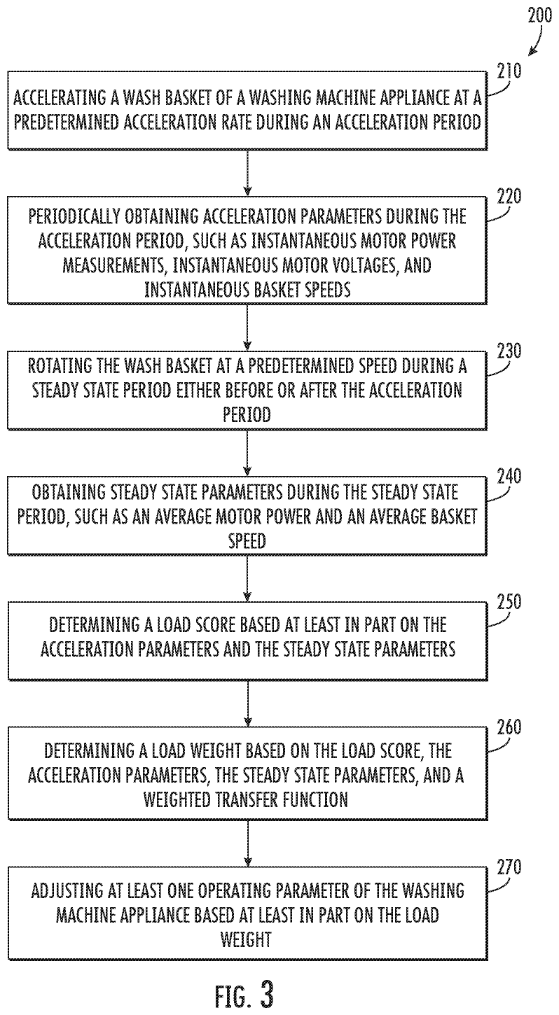

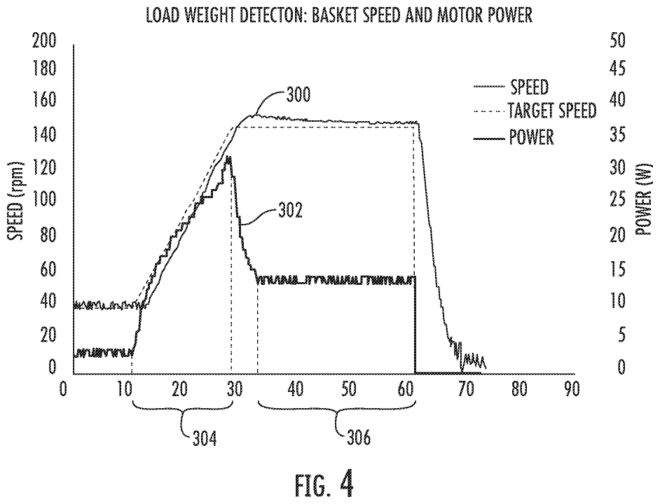

Referring generally to FIGS. 3 and 4, a method of determining load score and load weight during a load weight detection cycle and a plot of such a load weight detection cycle, respectively, are provided. For example, referring briefly to FIG. 4, a plot of the basket speed (e.g., in revolutions per minute, identified by reference numeral 300) and the motor power (e.g., in Watts, identified by reference numeral 302) over time during a load weight detection cycle is provided according to an exemplary embodiment of the present subject matter. As shown, method 200 may be a part of a load weight or load score detection cycle performed before a wash cycle for each new load of clothes or before/during a spin cycle. The load weight detection cycle generally includes a sequence of spin operations and corresponding measurements of the wash basket speed and motor power, as described in detail below.

Referring again to FIG. 3, method 200 includes, at step 210, accelerating a wash basket of a washing machine appliance at a predetermined acceleration rate during an acceleration period (e.g., as identified by reference numeral 304 in FIG. 4). In this regard, continuing the example from above, controller 166 may operate motor 122 to spin or rotate wash basket 120 after a new load of clothes has been added. Aspects of the present subject matter relate to approximating a load score or a load weight of the new load of clothes based at least in part on the motor power required to rotate wash basket 120, the spin speed of wash basket 120, and the motor voltage. Although exemplary systems and methods for making such measurements and implementing such spin profiles are described herein, it should be appreciated that variations and modifications may be made to washing machine appliance, its operation, and associated sensors and methods for detecting various operating parameters while remaining within the scope of the present subject matter.

For example, step 220 may include periodically obtaining acceleration parameters during the acceleration period 304. As used herein, the term “acceleration parameters” is generally intended to refer to operating parameters of any component of washing machine appliance 100 during the acceleration period 304 that might be useful for determining a load score or weight. For example, according to the exemplary load score and load weight calculations below, the acceleration parameters may include instantaneous motor power measurements, instantaneous basket speeds, and the average motor voltage during the acceleration period 304. However, it should be appreciated that according to alternative embodiments, any other suitable acceleration parameters may be factored into the load score or load weight calculations.

In this regard, for example, controller 166 may take a series of periodic measurements or samples (n) of each of the instantaneous motor power, the instantaneous basket speed, and the instantaneous motor voltage during the acceleration period 304. These measurements may be taken at a fixed rate or at a variable rate throughout the entire acceleration period or during a subset of the acceleration period. For example, in order to avoid transient measurements at the start and stop of the acceleration cycle, step 220 may include obtaining such periodic measurements during a measurement period that is shorter in duration and entirely within the acceleration period, e.g., such that a measurement time delay is implemented after the acceleration cycle begins and before the acceleration cycle ends.

It should be appreciated that any suitable measurement method, sampling rate, or measured variables may be used as a proxy for motor power, basket speed, and motor voltage. For example, according to an exemplary embodiment, motor current is measured and used as a proxy for motor power. In addition, or alternatively, the target basket speed may be used as a proxy for the basket speed. In this manner, according to exemplary embodiments, the present algorithm may assume the basket is always spinning at the target speed. According to exemplary embodiments, motor voltage may be approximated using system or appliance voltage. According to still other embodiments, obtaining the basket speed of the wash basket may include measuring a motor frequency, a back electromotive force (EMF) on the motor, or a motor shaft speed (e.g., using a tachometer). It should be appreciated that other systems and methods for monitoring motor power and/or basket speeds may be used while remaining within the scope of the present subject matter.

Step 230 includes rotating the wash basket at a predetermined speed during the steady state period. Notably, the steady state period (e.g., as identified by reference numeral 306 in FIG. 4) may be either before or after the acceleration period 304. According to the illustrated embodiment shown in FIG. 4, the steady state period 306 occurs after the acceleration period 304. In general, during the steady state period 306, the motor 122 maintains the rotation of the wash basket at a predetermined speed. In this regard, for example, the acceleration period 304 may continue until the wash basket is spinning at a predetermined speed, e.g., such as 150 revolutions per minute (RPM). Alternatively, the wash basket may be maintained a lower steady state speed prior to the acceleration period 304.

According to the illustrated embodiment where the steady state period 306 is after the acceleration period 304, step 230 includes maintaining the wash basket speed at this predetermined speed during the steady state period 306. Step 240 includes obtaining steady state parameters during the steady state period 306. As used herein, “steady state parameters” are generally intended to refer to operating parameters of any component of washing machine appliance 100 during the steady state period 306. For example, according to the exemplary load score and load weight calculations below, the steady state parameters may include an average motor power and an average basket speed during the steady state period 306. However, it should be appreciated that according to alternative embodiments, any other suitable steady state parameters may be factored into the load score or load weight calculations.

In this regard, controller 166 may monitor the basket speed and motor power over steady state period 306 and may take a statistical average at step 240. Alternatively, controller 166 may take a single measurement that may be used as the statistical average. Other methods of sampling and statistically determining the average basket speed and motor power over the steady state period 306 may be used while remaining within the scope of the present subject matter. In addition, similar to the measurement period during the acceleration period, the steady state measurements may be taken only in a subset of the steady state period 306, e.g., to avoid transients from introducing inaccuracy into the steady state motor power and basket speed.

Method 200 further includes, at step 250, determining a load score based at least in part on the acceleration parameters and the steady state parameters. For example, according to one exemplary embodiment, the load score may be based on instantaneous motor power measurements, the instantaneous basket speeds, the average motor power, and the average basket speed. In this regard, for example, determining the load score may include subtracting a summation of the instantaneous basket speeds times the average motor power divided by the average basket speed from a summation of the instantaneous motor power measurements. More specifically, according to an exemplary embodiment, determining the load score may include using the following equation:

$$L S = ( {\sum }_{i = 0}^{n} {P}_{a c c} - \frac{{P}_{avg , ss}}{{ω}_{avg , ss}} \times {\sum }_{i = 0}^{n} {ω}_{a c c} ) \times \frac{100}{n}$$

where: LS=a normalized load score;
n=a number of samples taken during the acceleration period;
P_{acc}=the motor power during the acceleration period;
P_{avg,ss}=the average motor power during the steady state period;
ω_{avg,ss}=the average basket speed during the steady state period; and
ω_{acc}=the basket speed during the acceleration period.

It should be appreciated that the equation provided above may vary while remaining within the scope of the present subject matter. For example, the number of samples taken, the frequency of samples taken, the variables measured, and other scaling factors may vary according to alternative embodiments. Such variations shall remain within the scope of the present subject matter. Furthermore, it should be appreciated that method 200 for determining the load score is only one exemplary method used for the purpose of explaining aspects of the present subject matter. Any other suitable method of calculating or determining a load score may be used while remaining within the scope of the present subject matter. For example, other exemplary methods of calculating a load score are described in U.S. Pat. No. 9,206,538 to Suel et al., the disclosure of which is incorporated herein by reference in its entirety for all purposes.

According to exemplary embodiments, method 200 may further include, at step 260, determining a load weight based on the load score (e.g., as measured at step 250), the acceleration parameters, the steady state parameters, and a weighted transfer function. In this regard, for example, a precise load weight, e.g., in pounds or kilograms, may be calculated based at least in part on the load score. For example, determining the load weight may include using a transfer function to convert an average of the instantaneous motor voltages, a summation of the instantaneous motor power measurements, a summation of the instantaneous basket speeds, and the average motor power into a load weight. More specifically, according to an exemplary embodiment, determining the load weight may include using the following weighted transfer function:

LW=A+B·LS+C·V_{avg,acc}+D·LS·V_{avg,acc}+E·P_{sum,acc}+F·ω_{sum,acc}+G·P_{avg,ss}

where: LW=a normalized load weight;
A−G=fixed constants;
LS=a normalized load score;
V_{avg,acc}=an average motor voltage during the acceleration period;
P_{sum,acc}=a summation of the motor power during the acceleration period;
ω_{sum,acc}=a summation of the basket speed during the acceleration period; and
P_{avg,ss}=the average motor power during the steady state period. It should be appreciated that the weighted transfer function provided above may vary while remaining within the scope of the present subject matter. For example, the weighting values A through G may vary depending on the specific appliance, the appliance model, or any other suitable factors. These scaling factors may be determined empirically, based on models, or using any other suitable calculations. In addition, the manner in which the load score is calculated may vary, along with the frequency of samples taken and the variables measured according to alternative embodiments. Such variations shall remain within the scope of the present subject matter. Furthermore, it should be appreciated that method 200 for determining the load weight is only one exemplary method used for the purpose of explaining aspects of the present subject matter. Any other suitable method of calculating or determining a load weight may be used while remaining within the scope of the present subject matter.

Notably, as explained above, the load weight or load score may affect the washing performance of washing machine appliance 100. Therefore, method 200 may further include, at step 270, adjusting at least one operating parameter of the washing machine appliance based at least in part on the load score or the load weight. As used herein, an “operating parameter” of washing machine appliance 100 is any cycle setting, operating time, component setting, spin speed, part configuration, or other operating characteristic that may affect the performance of washing machine appliance 100. Thus, references to operating parameter adjustments or “adjusting at least one operating parameter” are intended to refer to control actions intended to improve system performance based on the load weight or other system parameters. For example, adjusting an operating parameter may include adjusting an additive dispense amount, adjusting an agitation time or an agitation profile, adjusting a water level, limiting a spin speed of wash basket 120, etc. Other operating parameter adjustments are possible and within the scope of the present subject matter.

FIG. 3 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using washing machine appliance 100 as an example, it should be appreciated that these methods may be applied to the operation of any suitable washing machine appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance comprising:
a wash tub positioned within a cabinet and defining a wash chamber;
a wash basket rotatably mounted within the wash tub and being configured for receiving of a load of articles for washing;
a motor operably coupled to the wash basket for selectively rotating the wash basket; and
a controller operably coupled to the motor, the controller being configured for:
accelerating the wash basket at a predetermined acceleration rate during an acceleration period;
periodically obtaining acceleration parameters during the acceleration period;
rotating the wash basket at a predetermined speed during a steady state period either before or after the acceleration period;
obtaining steady state parameters during the steady state period;
determining a load score based at least in part on the acceleration parameters and the steady state parameters; and
determining a load weight based on the load score, the acceleration parameters, the steady state parameters, and a weighted transfer function.

2. The washing machine appliance of claim 1, wherein the acceleration parameters comprise instantaneous motor power measurements, instantaneous motor voltages, and instantaneous basket speeds, and wherein the steady state parameters comprise an average motor power.

3. The washing machine appliance of claim 2, wherein determining the load weight comprises:
determining a load weight based on the load score, an average of the instantaneous motor voltages, a summation of the instantaneous motor power measurements, a summation of the instantaneous basket speeds, and the average motor power.

4. The washing machine appliance of claim 2, wherein the weighted transfer function comprises:
LW=A+B·LS+C·V_{avg,acc}+D+LS·V_{avg,acc}+E·P_{sum,acc}+F·ω_{sum,acc}+G·P_{avg,ss}
where: LW=a normalized load weight;
A−G=fixed constants;
LS=a normalized load score;
V_{avg,acc}=an average motor voltage during the acceleration period;
P_{sum,acc}=a summation of the motor power during the acceleration period;
ω_{sum,acc}=a summation of the basket speed during the acceleration period; and
P_{avg,ss}=the average motor power during the steady state period.

5. The washing machine appliance of claim 4, wherein an appliance voltage is measured as a proxy for the average motor voltage.

6. The washing machine appliance of claim 1, wherein steady state parameters further comprise:
an average basket speed measured during the steady state period.

7. The washing machine appliance of claim 6, wherein determining the load score comprises:
determining the load score based on the instantaneous motor power measurements, the instantaneous basket speeds, the average motor power, and the average basket speed.

8. The washing machine appliance of claim 6, wherein determining the load score comprises using the following equation:
$$L S = ( {\sum }_{i = 0}^{n} {P}_{a c c} - \frac{{P}_{avg , ss}}{{ω}_{avg , ss}} \times {\sum }_{i = 0}^{n} {ω}_{a c c} ) \times \frac{100}{n}$$
where: LS=a normalized load score;
n=a number of samples taken during the acceleration period;
P_{acc}=the instantaneous motor power measurements during the acceleration period;
P_{avg,ss}=the average motor power during the steady state period;
ω_{avg,ss}=the average basket speed during the steady state period; and
ω_{acc}=the instantaneous basket speeds during the acceleration period.

9. The washing machine appliance of claim 6, wherein the predetermined speed is used as a proxy for the average basket speed.

10. The washing machine appliance of claim 2, wherein a motor current is measured as a proxy for motor power.

11. The washing machine appliance of claim 1, wherein the controller is further configured for:
adjusting at least one operating parameter of the washing machine appliance based at least in part on the load weight.

12. The washing machine appliance of claim 11, wherein adjusting the at least one operating parameter comprises:
adjusting an additive dispense amount, adjusting an agitation time or profile, adjusting a water level, or limiting a spin speed.

13. A method of operating a washing machine appliance, the washing machine appliance comprising a wash basket rotatably mounted within a wash tub and a motor operably coupled to the wash basket for selectively rotating the wash basket, the method comprising:
accelerating the wash basket at a predetermined acceleration rate during an acceleration period;
periodically obtaining acceleration parameters during the acceleration period;
rotating the wash basket at a predetermined speed during a steady state period either before or after the acceleration period;
obtaining steady state parameters during the steady state period;
determining a load score based at least in part on the acceleration parameters and the steady state parameters; and
determining a load weight based on the load score, the acceleration parameters, the steady state parameters, and a weighted transfer function.

14. The method of claim 13, wherein the acceleration parameters comprise instantaneous motor power measurements, instantaneous motor voltages, and instantaneous basket speeds, and wherein the steady state parameters comprise an average motor power.

15. The method of claim 14, wherein determining the load weight comprises:
determining a load weight based on the load score, an average of the instantaneous motor voltages, a summation of the instantaneous motor power measurements, a summation of the instantaneous basket speeds, and the average motor power.

16. The method of claim 14, wherein the weighted transfer function comprises:
LW=A+B·LS+C·V_{avg,acc}+D·LS·V_{avg,acc}+E·P_{sum,acc} F·ω_{sum,acc}+G·P_{avg,ss}
where: LW=a normalized load weight;
A−G=fixed constants;
LS=a normalized load score;
V_{avg,acc}=an average motor voltage during the acceleration period;
P_{sum,acc}=a summation of the motor power during the acceleration period;
ω_{sum,acc}=a summation of the basket speed during the acceleration period; and
P_{avg,ss}=the average motor power during the steady state period.

17. The method of claim 16, wherein an appliance voltage is measured as a proxy for the average motor voltage.

18. The method of claim 13, wherein steady state parameters further comprise an average basket speed measured during the steady state period, and wherein determining the load score comprises using the following equation:
$$L S = ( {\sum }_{i = 0}^{n} {P}_{a c c} - \frac{{P}_{avg , ss}}{{ω}_{avg , ss}} \times {\sum }_{i = 0}^{n} {ω}_{a c c} ) \times \frac{100}{n}$$
where: LS=a normalized load score;
n=a number of samples taken during the acceleration period;
P_{acc}=the instantaneous motor power measurements during the acceleration period;
P_{avg,ss}=the average motor power during the steady state period;
ω_{avg,ss}=the average basket speed during the steady state period; and
ω_{acc}=the instantaneous basket speeds during the acceleration period.

19. The method of claim 13, wherein the controller is further configured for:
adjusting at least one operating parameter of the washing machine appliance based at least in part on the load weight.

20. The method of claim 19, wherein adjusting the at least one operating parameter comprises:
adjusting an additive dispense amount, adjusting an agitation time or profile, adjusting a water level, or limiting a spin speed.
